(19) United States
(12) Patent Application Publication
(10) Pub. No.: US 2026/0126776 A1
(43) Pub. Date: May 7, 2026

(54) SINGLE-CLICK VIRTUAL INTERFACE LAUNCH

(71) Applicant: SPOKBEE INC, Avon, OH (US)

(72) Inventors: Michael Andrew CAMERON, Avon, OH (US); Karina CAMERON, Avon, OH (US); Imants Ojars SMIDCHENS, Seattle, WA (US); Victor Alekseyevich KOJENOV, Box Elder, SD (US); Sheamin KIM, Bellevue, WA (US)

(21) Appl. No.: 19/371,424

(22) Filed: Oct. 28, 2025

Related U.S. Application Data
(60) Provisional application No. 63/715,747, filed on Nov. 4, 2024.

(51) Int. Cl. G05B 19/4099; G06F 3/04815; G06F 3/0482; G06F 3/0484; G06F 9/451

(52) U.S. Cl. CPC G05B 19/4099; G06F 3/04815; G06F 3/0482; G06F 3/0484; G06F 9/451; G05B 2219/49023

(57) ABSTRACT

Various implementations disclosed herein include systems, methods, and apparatuses for automatically generating a customizable virtual interface embedded in a platform. For example, a specialized interface configured to provide communications between a user and the electronic device may be presented in response to a single executed action and in response to a prompt from the user executed via the specialized interface, sensor and apparatus design data associated with generating a virtual interface is obtained from external systems. The virtual interface is configured to enable actions associated with enabling the user to create a specialized structure. The process may further generate the virtual interface embedded in a platform based on the sensor and apparatus design data and may include potential configurations of the specialized structure. 3D renderings of the plurality of potential configurations of the specialized structure may be presented to the user via the virtual interface.

### TECHNICAL FIELD

The present disclosure generally relates to systems, methods, and devices that may generate a configurable virtual interface to enable iterative design and construction of a specialized product or structure.

### BACKGROUND

Existing systems for building physical structures typically require manual configuration and may lack real-time visualization thereby leading to high latency and limited customization options. Accordingly, there exists a need in the art to overcome at least some of deficiencies and limitations described herein above.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In one embodiment, a method for generating a configurable virtual interface to enable iterative design and construction of a specialized structure is provided. The method is performed at an electronic device having a processor and includes: in response to a single executed action, presenting a specialized interface configured to provide communications between a user and the electronic device; in response to a prompt from the user executed via the specialized interface, obtaining from a plurality of external systems, sensor and apparatus design data associated with generating a virtual interface configured to enable actions associated with enabling the user to create a specialized structure; generating the virtual interface embedded in a platform based on the sensor and apparatus design data, the virtual interface comprising a plurality of potential configurations of the specialized structure; presenting to the user via the virtual interface, 3D renderings of the plurality of potential configurations of the specialized structure; and based on the sensor and apparatus design data, presenting to the user via the virtual interface, recommendations associated with selections from the plurality of potential configurations of the specialized structure.

In one embodiment, a system for generating a configurable virtual interface to enable iterative design and construction of a specialized structure is provided. The system includes a non-transitory computer-readable storage medium and one or more processors coupled to the non-transitory computer-readable storage medium that comprises program instructions that, when executed on the one or more processors, cause the system to perform operations comprising: in response to a single executed action, presenting a specialized interface configured to provide communications between a user and the electronic device; in response to a prompt from the user executed via the specialized interface, obtaining from a plurality of external systems, sensor and apparatus design data associated with generating a virtual interface configured to enable actions associated with enabling the user to create a specialized structure; generating the virtual interface embedded in a platform based on the sensor and apparatus design data, the virtual interface comprising a plurality of potential configurations of the specialized structure; presenting to the user via the virtual interface, 3D renderings of the plurality of potential configurations of the specialized structure; and based on the sensor and apparatus design data, presenting to the user via the virtual interface, recommendations associated with selections from the plurality of potential configurations of the specialized structure. The system may ensure robust operation by validating inputs and resolving conflicts in real-time using AI-driven analysis.

In one embodiment, a non-transitory computer-readable storage medium is provided. The non-transitory computer-readable storage medium includes instructions executable via one or more processors to perform operations comprising: in response to a single executed action, presenting a specialized interface configured to provide communications between a user and the electronic device; in response to a prompt from the user executed via the specialized interface, obtaining from a plurality of external systems, sensor and apparatus design data associated with generating a virtual interface configured to enable actions associated with enabling the user to create a specialized structure; generating the virtual interface embedded in a platform based on the sensor and apparatus design data, the virtual interface comprising a plurality of potential configurations of the specialized structure; presenting to the user via the virtual interface, 3D renderings of the plurality of potential configurations of the specialized structure; and based on the sensor and apparatus design data, presenting to the user via the virtual interface, recommendations associated with selections from the plurality of potential configurations of the specialized structure.

In one embodiment, a non-transitory computer-readable storage medium is provided. The non-transitory computer-readable storage medium includes instructions executable via one or more processors to perform operations comprising: In accordance with some implementations, a device includes one or more processors, a memory, and one or more programs; the one or more programs are stored in the memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates a pipeline that enables the automatic creation of a customizable virtual online interface that connects users with product or structure design, configuration, and manufacturing/build capabilities, in accordance with some implementations.

FIG. 2 illustrates a framework configured to process main categories of inputs, tasks, processes, internal assets generated, and outputs to enable operation of an automated virtual storefront generation system, in accordance with some implementations.

FIG. 3 illustrates secondary actions performed by a virtual interface and a manufacturing process to complete a product/structure lifecycle from virtual interface interaction and customization through automated manufacturing, delivery, and post configuration optimization, in accordance with some implementations.

FIG. 4 illustrates a method for generating, displaying, and refining a 3D visualization of a customizable product/structure derived from various forms of user input, in accordance with some implementations.

FIG. 5 illustrates a method for identifying, generating, and displaying configurable parameters of a product/structure, in accordance with some implementations.

FIG. 6 illustrates a method for automatically generating a user interface/user experience (UI/UX) design, layout, and functionality for a virtual interface, in accordance with some implementations.

FIG. 7 illustrates a method for evaluating the manufacturability of a product/structure and recommending an optimal production method based on technical, operational, and market factors, in accordance with some implementations.

FIG. 8 illustrates a plurality of UI elements that may be used for generating a virtual interface, in accordance with some implementations.

FIG. 9 illustrates a UI to provide users to input product information for virtual interface setup, in accordance with some implementations.

FIG. 10 illustrates a UI to provide users to define configurable parameters for CAD models using UI elements such as sliders or step increments, in accordance with some implementations.

FIG. 11 illustrates a UI to enable users to collect manufacturing details to generate a manufacturing feasibility score (MFS), determine an optimal method of manufacturing for a product and varying versions, and predict pricing, in accordance with some implementations.

FIG. 12 illustrates a UI to enable users to collect additional input to further predict product pricing, in accordance with some implementations.

FIG. 13 illustrates a UI to enable users to collect seller information regarding product shipping, in accordance with some implementations.

FIG. 14 illustrates a UI to provide sellers or designers a centralized view of all their products or virtual interfaces, in accordance with some implementations.

FIG. 15 illustrates a method for executing AI inference locally rather than relying on cloud-based processing, in accordance with some implementations.

FIG. 16 illustrates a method for iterative enabling parametric design and optimization to automatically refine product parameters to achieve predefined performance, manufacturability, and constraint conditions, in accordance with some implementations.

FIG. 17 illustrates an example of a configuration UI panel and 3D product render for a drawer system, in accordance with some implementations.

FIG. 18 illustrates an example of a user interface for creating and managing a complete truck lifecycle configuration including new builds and component replacement, in accordance with some implementations.

FIG. 19 illustrates a method for automatically generating and deploying a fully functional virtual interface from a parametric product model and associated client information, in accordance with some implementations.

FIG. 20 illustrates a method for retrieving publicly available 3D CAD models, systematically varying corresponding configurations and feature history, and exporting structured 3D data along with parametric metadata for machine learning (ML) training, in accordance with some implementations.

FIG. 21 illustrates a method for automatically launching a virtual interface that integrates manufacturer-specific pricing, production constraints, and feature functionality, in accordance with some implementations.

FIG. 22 illustrates a framework configured to automatically generate a virtual interface embedded within a platform in response to a single user action, in accordance with some implementations.

FIG. 23 is a flowchart representation of an exemplary method that generates a configurable virtual interface to enable iterative design and construction of a specialized structure, in accordance with some implementations.

FIG. 24 illustrates a hardware device for improving technology associated with creating a one click product storefront launch, in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

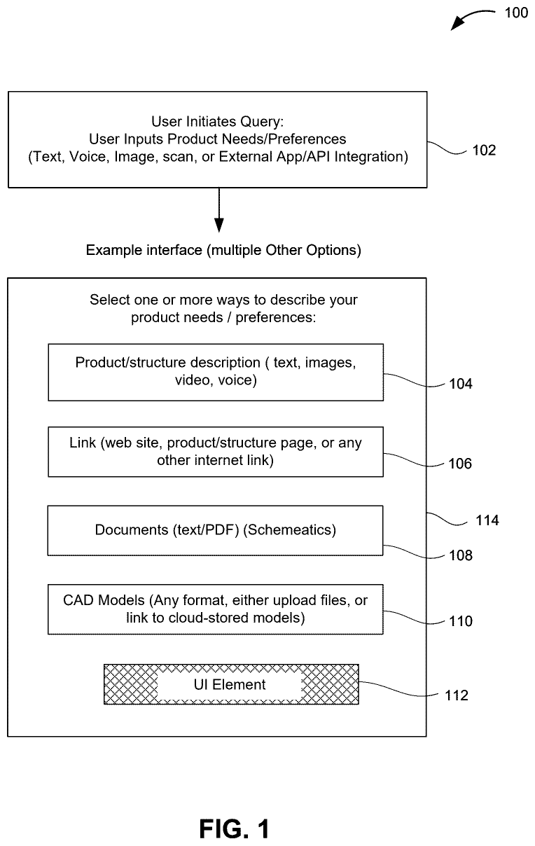

FIG. 1 illustrates a pipeline 100 that enables the automatic creation of a customizable virtual online interface (e.g., a storefront) that connects users with product or structure design, configuration, and manufacturing/build capabilities, in accordance with some implementations. A product or structure may include, inter alia, a software structure (e.g., an application or computer code) , a hardware structure (e.g., a computer or mobile device), a mechanical structure (e.g., a toolbox), an electrical structure (e.g., a television), an electro/mechanical structure (e.g., a vehicle, a power tool, etc.), an item (e.g., a tire or wheel), etc. In some implementations, a single user action (e.g., clicking a physical or virtual button such as UI element 112) may be used to generate, launch and/or modify launch of the virtual interface. The virtual interface may include (a) configurators for customizing virtual interface and an associated product or structure; (b) dynamic manufacturing request tools integrated into the virtual interface; and (c) embedded digital features such as 3D product visualization, content for presentation, and media integration.

The pipeline 100 implements the following functionality: (a) automated virtual interface generation; (b) artificial intelligence (AI) and machine learning (ML) configuration functionality; (c) intelligent model generation; (d) real-time rendering and fulfillment integration; and (e) digital/virtual feature launching.

In some implementations, automated virtual interface generation may be enabled via minimal user input (e.g., via a single user interface (UI) element 112 click or predefined parameters) and may use templates or rule-based logic to populate virtual interface structure, layout, and design assets. The virtual interface may be customizable via the use of AI/ML engines and/or via user input.

In some implementations, an AI and ML configuration engine may be configured to analyze diverse input types such as, for example, images, videos, 3D CAD models, sensor data (including video, audio, text, biometric sensor data), historical purchase data, competitor data, user profiles or behavioral data, etc. Likewise, the AI and ML configuration engine may be further configured to determine whether an existing product/structure model may meet a user's needs and in response configure and render a corresponding 3D model in real time.

In some implementations, intelligent model generation may include identifying core components (e.g., geometry, dimensions, materials, tolerances, features, etc.) of an existing or new structure. In some implementations, core components may be used to generate base configurable models/structures with editable 3D parameters such as, for example, dimensions, texture, functionality, patterns, faces, extrudes, holes, chamfers, etc.) and the virtual interface may be updated with the base configurable models/structures.

In some implementations, real-time rendering and fulfillment integration functionality may include generating interactive 3D models that reflect design changes in real time thereby reducing latency between design and manufacturing handoff.

In some implementations, digital/virtual feature launching may trigger, inter alia, 3D visualization tools, virtual presentation campaigns, media content generation, augmented or virtual reality previews, etc.

Pipeline 100 illustrates a query component described via query module 102, with an example of a specialized interface 114. In some implementations, a process for creating a customizable virtual online interface is initiated when a user interacts with specialized interface 114 (e.g., web, mobile, or API-based) via query module 102 using one or more input modalities such as for example, text entry (e.g., typing or selecting from menus), voice input (e.g., verbal description of product or function, image input (e.g., photo, sketch, scanned object, etc.), 3D scan or sensor data (e.g., dimensions, shapes, etc.), external application/API integration (e.g., importing specifications from design software, marketplace platforms, computer aided design (CAD), etc.), etc.

In some implementations, specialized interface 114 is configured to enable users to select one or more input methods to describe their product/structure needs and preferences. For example, a user may provide input via any combination of the following input types: (a) product description 104 via text, images, video, or voice input used to describe a desired product/structure and associated features, specifications, or intended use; (b) a Web link(s) 106 that may include uniform resource locator(s) (URL) referencing relevant online sources such as company websites, product/structure pages, or any other internet-based content containing design or product information; (c) documents 108 such as uploaded text or PDF files including any type of relevant data such as specification data, schematics or any other type supporting documentation; (d) CAD models 110 such as 2D or 3D CAD files in any format provided via direct upload or linked from cloud storage or integrated design platforms.

Upon receiving input via the specialized interface 114, the pipeline 100 is configured to automatically analyze the data and generate a corresponding virtual interface that may be preconfigured with relevant products, configurators, and associated marketing materials.

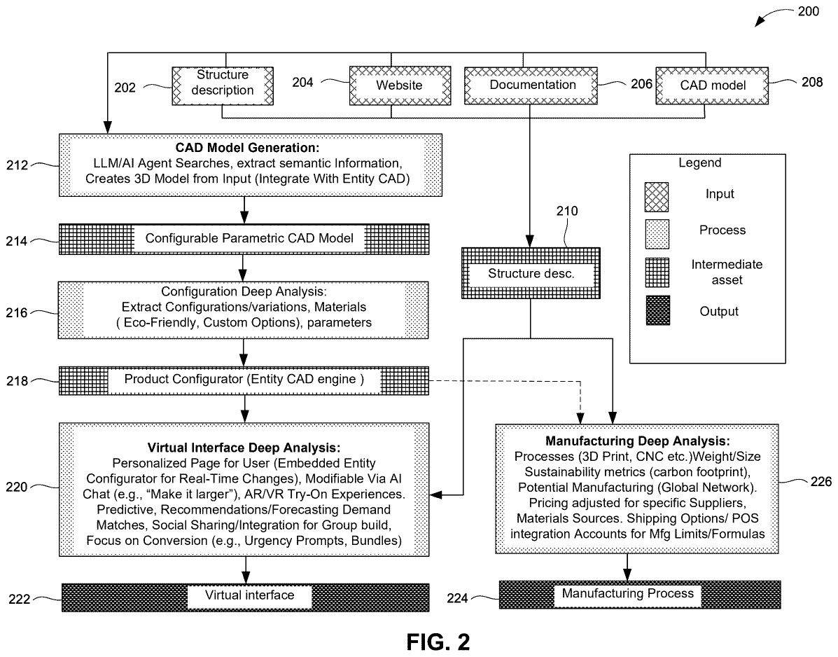

FIG. 2 illustrates a framework 200 configured to process main categories of inputs, tasks, processes, internal assets generated, and outputs to enable operation of an automated virtual interface generation system, in accordance with some implementations. For example, the following inputs may be provided directly by a user when initiating virtual interface generation or product/structure configuration: (a) a description 202 of the structure that may include a conceptual description of the structure that may be provided via text, images, or sketches and may include functional requirements, design preferences, materials, dimensions, or aesthetic details; (b) a corresponding Website 204 such as a link to an entity's website that may include a company identity, brand elements, product descriptions, multimedia content (text, images, videos), etc. ; (c) documentation that may include reference to a specific product or product line and may be provided as a webpage link or a document (e.g., text, PDF) that includes detailed information such as features, images, and multimedia assets; and (d) a CAD model that may include a 2D or 3D digital model of the product that includes configurable parameters, features, materials, and/or tolerance information.

In some implementations, framework 200 may be configured to enable AI/ML driven modules to generate internal assets and perform analytical and configurational tasks leading to creation of a virtual interface 222.

In some implementations, a module 212 may be configured to automatically generate a configurable 3D CAD model from textual, visual, or structured product input. For example, a large language model (LLM) or AI agent may be configured to analyze textual and visual input (e.g., descriptions, sketches, images, etc.) to identify core geometric, material, and functional attributes and create a base 3D model integrating with an entity based CAD platform for model synthesis and rendering. Subsequently, the generated 3D model may be converted (via module 214) into a configurable parametric CAD model to allow dynamic modification of key parameters such as dimensions, materials, tolerances, textures, structural features, etc.

In some implementations, a module 216 may be configured to enable AI models to perform analysis of potential configurations and variations for the configurable parametric CAD model that may identify, for example, customization options, material alternatives (including eco-friendly or sustainable materials), manufacturability and tolerance constraints, associated production lead times, etc. In some implementations, an entity CAD engine 218 may automatically create a product configurator that enables relevant adjustable parameters for end-user interaction within the virtual interface 222.

In some implementations, a module 210 may be configured to automatically create detailed product/structure descriptions and content linked to the generated 3D model. For example, AI models may be used to synthesize structured product descriptions, specifications, and feature lists from the generated 3D CAD model and related semantic data. Likewise, corresponding descriptions may be formatted for virtual interface integration via text, imagery, multimedia assets and outputs including 3D renderings, animation previews, and interactive model viewers created for digital presentation.

In some implementations upon completion of the aforementioned analysis and model generation processes, framework 200 is configured produce two distinct modules: virtual interface deep analysis module 220 and manufacturing deep analysis and automation module 226. Virtual interface deep analysis module 220 may be configured to create an AI-driven virtual interface 222 optimized for user engagement, configurability, and conversion by: (a) generating a dedicated interface tailored to an individual user or target manufacturing segment. The interface may include an embedded configurator to enable real-time product/structure customization and visualization directly within the interface; (b) enabling integrated conversational AI functionality to allow users to modify configurations or negotiate terms through natural language commands such as, for example, “Make it larger,” “Show a different color,” etc.; (c) supporting AR/VR wearable device or placement experiences to enable users to visualize products/structures in context; (d) utilize AI models to analyze behavior and preferences to provide personalized recommendations, predict demand patterns, and align product configurations with user intent; (e) providing built-in options for social media sharing or collaborative configuration to encourage viral engagement and community-driven behavior; and (f) providing conversion optimization enabling AI functionality to dynamically manage interface elements (e.g., urgency prompts, limited-time bundles, etc.) to maximize structure builds.

Manufacturing deep analysis and automation module 226 may be configured to determine and initiate the optimal development of a manufacturing and automated build process 224 based on product configuration and sustainability metrics by (a) automatically evaluating manufacturing options (e.g., 3D printing, CNC machining, injection molding, assembly line production, etc.) based on geometry, tolerances, materials, and batch volume; (b) identifying appropriate materials (including sustainable or low-carbon options) and matching the identified materials to potential manufacturers across a global supplier network; (c) calculating weight, size, and carbon footprint to ensure eco-friendly recommendations and compliance with sustainability goals; (d) providing real-time adjustment of pricing based on selected suppliers, materials, and shipping parameters; and (e) connecting to shipping, point-of-sale (POS), and inventory systems for seamless order execution and accounting for manufacturing constraints, formulas, and capacity limits to initiate the manufacturing and automated build process 224 without manual intervention.

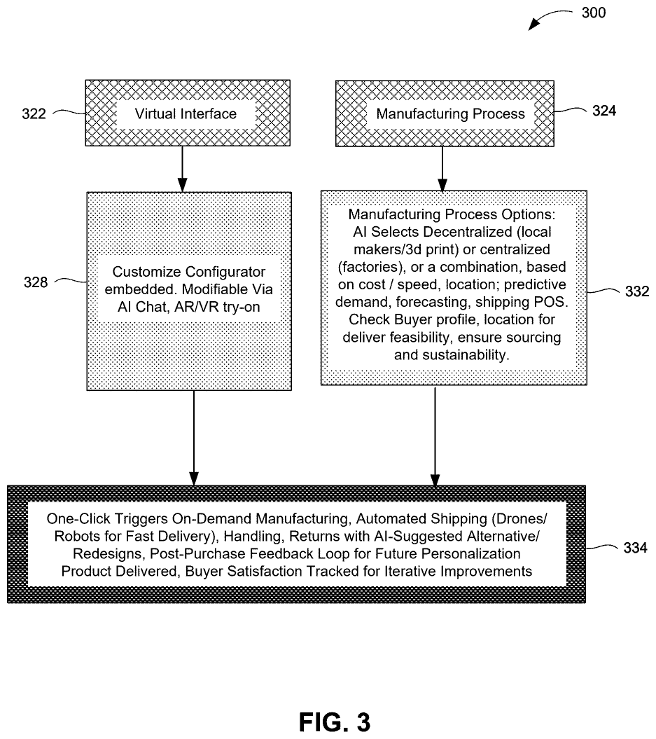

FIG. 3 illustrates secondary actions performed by a virtual interface 322 and a manufacturing process 324 to complete a product/structure lifecycle from virtual interface interaction and customization through automated manufacturing, delivery, and post configuration optimization, in accordance with some implementations. In some implementations, virtual interface 322 includes an embedded product configurator 328 that enables users to modify product attributes in real time. For example, product configurations may be modifiable via AI chat functionality or via augmented and virtual reality (AR/VR) device experiences to allow users to visualize products in their environment or on themselves. In some implementations, a manufacturing and automated build process (module) 324 includes an AI engine 332 for evaluating multiple manufacturing process options to select a most efficient manufacturing path. For example, decentralized production (e.g., local makerspaces, additive manufacturing hubs, or distributed 3D-printing networks), centralized production (e.g., large-scale factories or partner facilities), and hybrid production techniques may be implemented to select a manufacturing path. In some implementations, a manufacturing path may be selected based on production speed, geographic proximity, shipping logistics, and predictive demand forecasts.

In some implementations, once a user confirms a structure configuration, a one-click action 334 is enabled to trigger: (a) on-demand manufacturing initiation for generating a digital production package (e.g., CAD files, process parameters, etc.); (b) automated logistics orchestration including shipping and handling via autonomous delivery channels (e.g., drones, robots, local couriers, etc.); and (c) return management and redesign assistance such that an AI module is configured to suggest alternative configurations or redesigns based on return scenarios or feedback; and (d) post-production feedback and continuous personalization by tracking satisfaction using structured feedback, sensor data, etc. and using the tracking data to provide iterative improvements.

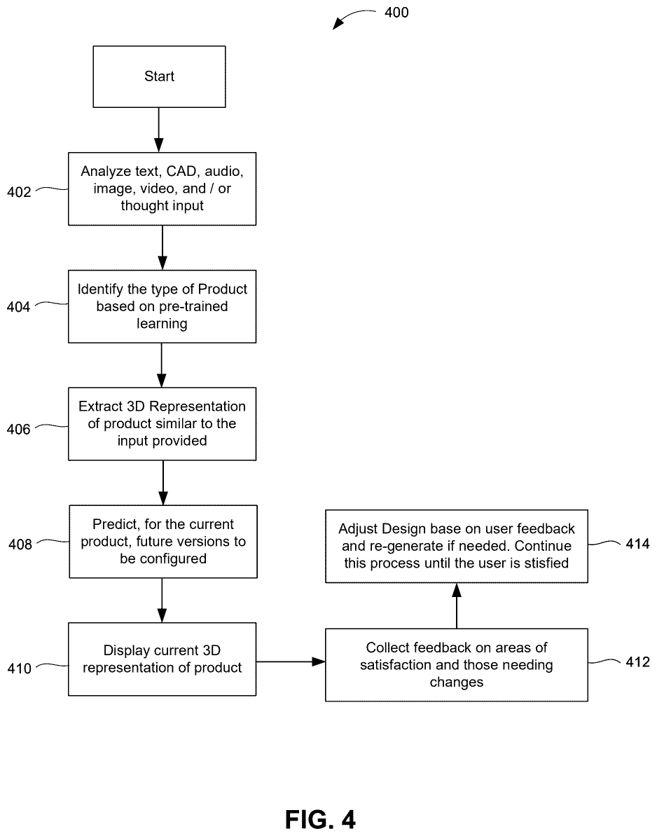

FIG. 4 illustrates a method 400 for generating, displaying, and refining a 3D visualization of a customizable product/structure derived from various forms of user input, in accordance with some implementations. The method 400 is configured to enable AI-driven semantic analysis, 3D model retrieval, predictive configuration, and iterative refinement via user feedback.

At block 402, the method 400 retrieves and analyzes input data from one or more modalities including, inter alia, text data, CAD files, audio data, image data, biometric data, etc. The input data may be captured via a user interface, sensors, uploaded documents, integrated external applications, etc.

At block 404, the method 400 enables AI models (e.g., trained on large datasets of product categories and attributes) to further analyze the input data to identify/classify a product type such as, for example, furniture, consumer electronics, mechanical components, vehicle components, etc. This classification may be based on semantic understanding, visual recognition, and metadata extraction.

At block 406, the method 400 extracts a 3D representation by querying internal and connected databases to locate and/or synthesize a 3D representation of a product that matches an identified product type and features inferred from the input data. If no exact match exists, the AI model may be configured to generate a base 3D model that approximates a described product and integrates with specialized CAD engine for rendering.

At block 408, the method 400 is configured to predict potential future variations or configurations of the product such as, for example, changes in size, material, color, functionality, modular structure, etc. Resulting predictive models may be configured to support dynamic customization thereby enabling users to explore design alternatives in real time.

At block 410, the method 400 displays a current 3D representation of the product within an interactive viewer within the virtual or design interface. This visualization feature may include allowing the user to visualize the current 3D representation of the product with respect to rotation, scaling, exploded views, parametric sliders, AR/VR options for immersive evaluation, etc.

At block 412, the method 400 enables users to interact with the 3D visualization to provide feedback with respect to satisfaction or desired modifications using gestures, text commands, AI chat (e.g., “make the surface smoother,” “change color,”, “add compartments”, etc.), etc. In some implementations, the method 400 may be configured to handle invalid inputs by, for example, validating user inputs and if non-manufacturable configurations are detected, AI systems may be used to suggest alternative parameters that meet manufacturing constraints.

At block 414, the method 400 analyzes the feedback, adjusts the 3D model accordingly, and regenerates an updated visualization to reflect the requested changes. This iterative process is configured to continue until a user confirms satisfaction with the design. Upon completion of the iterative process, the method 400 generates a finalized 3D product render which may represent anything from a simple object (e.g., a chair or lamp) to highly complex assemblies such as industrial furniture, machinery, or vehicle interiors with a detailed bill of materials and parametric configurations ready for manufacturing.

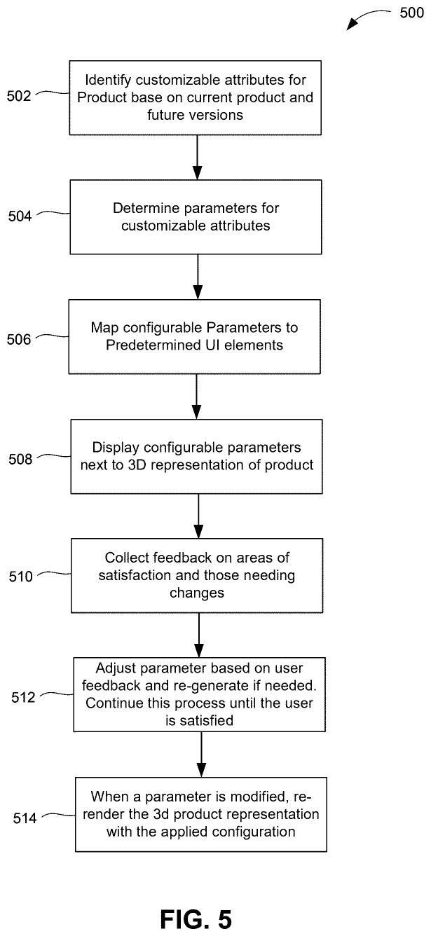

FIG. 5 illustrates a method 500 for identifying, generating, and displaying configurable parameters of a product/structure, in accordance with some implementations. The configurable parameters define how users may modify a product via an interactive configurator to ensure that each parameter is semantically mapped to a corresponding user interface (UI) element such as a slider, a dropdown menu, an input field, etc.

At block 502, the method 500 identifies customizable attributes by, for example, analyzing a current product model (and optionally predicted future versions) to identify which attributes may be customized (e.g., dimensions, color, materials, textures, mechanical features, component options, etc.).

At block 504, the method 500 determines parameters for customizable attributes by determining specific configurable parameters such as, for example, height, width, depth, color, material type, etc. Each parameter may include allowable value ranges, constraints, and dependencies derived from the underlying product data model or CAD configuration.

At block 506, the method 500 maps configurable parameters to UI elements based on parameter semantics and data type. For example, dimensional values may be mapped to a slider with a numeric input field, material options may be mapped to a dropdown selector, etc.

At block 508, the method 500 displays the configurable parameters with 3D product visualization. For example, the configurable parameters may be displayed adjacent to or overlaid on the 3D product visualization thereby allowing a user to adjust values in real time while observing immediate visual changes to the product model.

At block 510, the method 500 collects feedback with respect to user satisfaction. For example, as a user interacts with a configurator, the method may collect feedback regarding satisfaction, usability, or further desired modifications.

At block 512, the method 500 refines or adjusts parameter definitions, regenerates a 3D product model, and re-renders the updated visualization. Block 512 is iterative and continues until the user indicates satisfaction.

At block 514, the method 500 applies modified parameters for final render. For example, when a parameter modification is finalized, a 3D product representation may be rendered with the applied configuration thereby producing the user's customized version.

Accordingly, the method 500 enables parametric product configuration such that each user input dynamically influences the 3D model and associated data layer (e.g., materials, or manufacturability) thereby creating a real-time, interactive configurator experience integrated with AI-assisted design and production workflows.

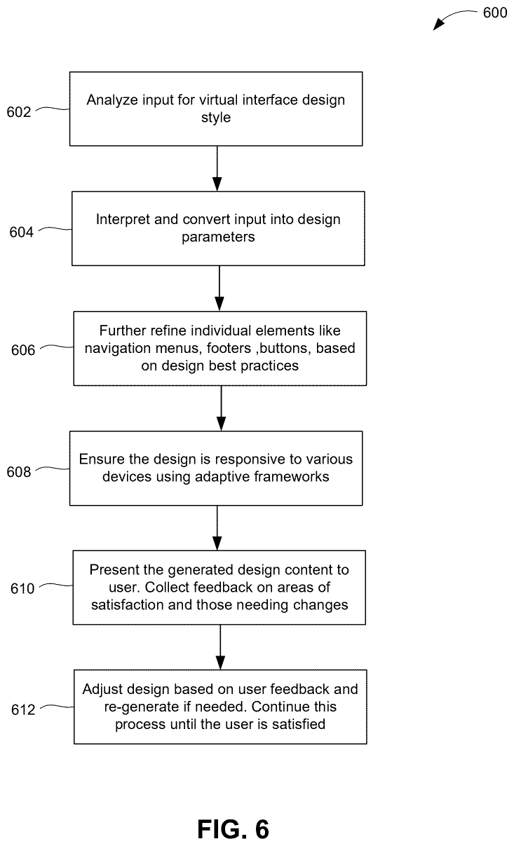

FIG. 6 illustrates a method 600 for automatically generating a user interface/user experience (UI/UX) design, layout, and functionality for a virtual interface, in accordance with some implementations. The method 600 may combine AI-driven interpretation, design heuristics, and responsive layout generation to produce a personalized, functional, and visually coherent virtual interface that may be further refined via user interaction and feedback.

At block 602, the method 602 analyzes input for creating a style for the virtual interface. For example, the method 600 may receive and analyze user-provided input related to design preferences such as, for example, visual themes, typography, brand identity, example websites, etc. The user provided input may include textual descriptions, reference images, guidelines, links to existing online entities, etc.

At block 604, the method 600 interprets and converts the user provided input into design parameters by converting the input into a structured set of design parameters, such as layout structure, color schemes, content density, etc. The design parameters may be configured to define structural rules governing the generated virtual interface.

At block 606, the method 600 refines individual design elements for the virtual interface by automatically refining and positioning individual UI elements including, for example, navigation menus, product cards, buttons, search bars, filters, etc. in accordance with design practices, accessibility standards, and UX heuristics.

At block 608, the method 600 verifies responsiveness across devices by validating a generated virtual interface design across multiple device types (e.g., desktop, tablet, mobile, etc.) using adaptive and responsive design frameworks. Layout elements may be dynamically adjusted for varying resolutions, aspect ratios, interaction models (e.g., touch vs. cursor), etc.

At block 610, the method 600 presents (to a user) a generated design for the virtual interface and obtains user feedback. For example, the generated virtual interface design may be presented to the user via an interactive preview interface and the user may provide explicit feedback (“move the logo higher,” “make it darker”, etc.) or implicit signals (time spent viewing, hover patterns, clicks, etc.) to indicate satisfaction or areas requiring revision.

At block 612, the method 600 may adjust and re-generate the virtual interface design based on user feedback. For example, the method 600 may iteratively interpret the feedback, refine design parameters, and re-generate the virtual interface layout and styling until the user confirms satisfaction with the overall appearance and functionality thereby enabling automated, adaptive virtual interface creation to produce a visually appealing, brand-consistent, and responsive UI without the need for manual design work.

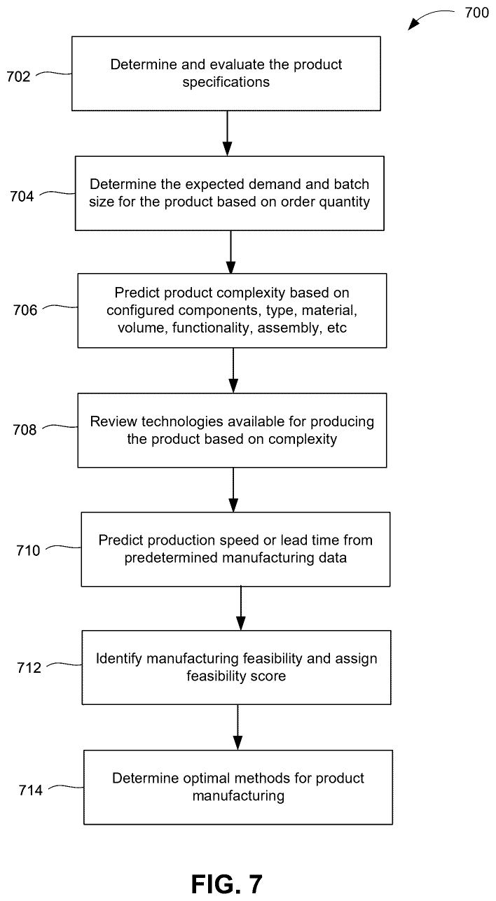

FIG. 7 illustrates a method 700 (e.g., implemented via an AI model) for evaluating the manufacturability of a product/structure and recommending an optimal production method based on technical, operational, and market factors, in accordance with some implementations. The method 700 may use structured input data derived from user-configured models, predicted demand, material selections, and manufacturing databases to compute a manufacturing feasibility score (MFS) representing a quantitative indicator of how efficiently and cost-effectively a product may be manufactured or built.

At block 702, the method 700 determines and evaluates product specifications by extracting relevant product specifications and standardizing them into machine-readable attributes for further processing. The relevant product specifications may be extracted from a user-generated configuration and associated data sources and may include a geometry, tolerances, materials, a finish, assembly requirements, functional constraints, etc.

At block 704, the method 700 determines an expected demand and batch size by predicting an anticipated order volume and batch size for the product by analyzing user orders, market trends, historical data, and real-time demand signals.

At block 706, the method 700 predicts product complexity by evaluating a number of configured components, material types, part geometries, functional dependencies, required assembly operations, etc.

At block 708, the method 700 reviews available manufacturing technologies based on an evaluated complexity by querying an internal or external database of manufacturing technologies (e.g., 3D printing, CNC machining, injection molding, sheet metal forming, casting, hybrid manufacturing, etc.) to determine feasible options. Each manufacturing technology may be scored in accordance with a compatibility with the product's material, dimensional tolerances, etc.

At block 710, the method 700 predicts a production speed or lead time using, for example, historical and real-time manufacturing performance data estimate production lead time and throughput for each feasible process accounting for setup time, machine utilization, and resource availability.

At block 712, the method 700 identifies manufacturing feasibility and assigns a feasibility score by integrating all specifications, demand, complexity, technology match, and lead time to calculate an MFS. The MFS may represent a weighted measure of manufacturability, balancing quality, cost, speed, and sustainability metrics (e.g., material efficiency, carbon footprint, etc.).

At block 714, the method 700 determines an optimal manufacturing method based on the calculated MFS. Determining an optimal manufacturing method may include selecting between centralized (factory-based) and decentralized (local maker or distributed 3D print) models or a hybrid approach to automatically initiate a digital manufacturing process to link suppliers or production facilities via an integrated manufacturing network. Accordingly, the method may combine AI-driven predictions with real manufacturing data to ensure that every user-generated product design may transition efficiently from a digital configuration (e.g., a 3D representation) to physical production.

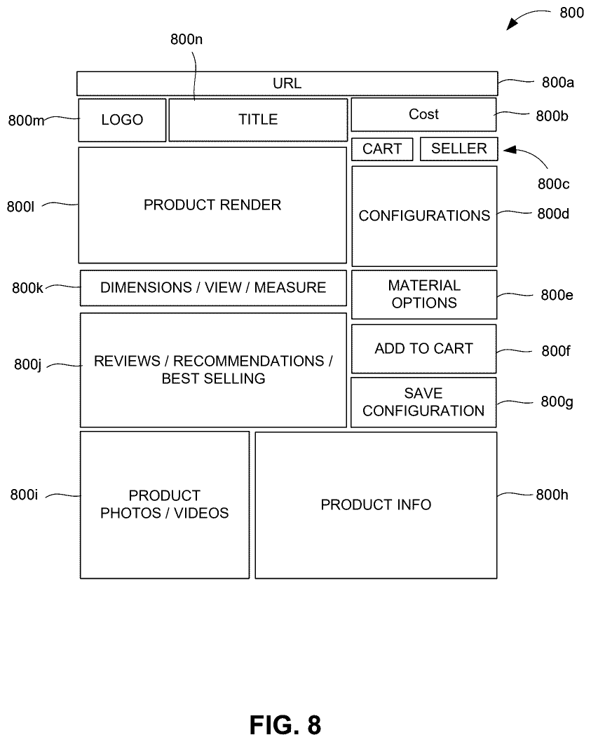

FIG. 8 illustrates a plurality of UI elements 800 that may be used for generating a virtual interface, in accordance with some implementations. For example, the plurality of UI elements 800 may include UI elements such as a URL element 800a, a cost element 800b, a cart/seller element 800c, a configurations element 800d, a material options element 800e, an add to cart element 800f, a save configuration element 800g, a product info element 800h, a product photos/videos element 800i, a reviews element 800j, a dimensions/view/measure element 800k, a product render element 800l, a log element 800m, and a title element 800n.

The UI elements 800 are configured to provide UI functionality for a dynamic virtual interface display to create a configurable product. For example, UI elements 800 may enable functionality associated with, inter alia, providing: a clear display name for product, a direct link to the product page, an internal identifier for tracking and inventory, a company or product logo displayed in the virtual interface, a main product render or promotional image, a gallery of images illustrating the product from different angles, an interactive 3D view, a textual overview of product features, benefits, and use cases, technical specifications/dimensions such as length, width, height, weight, volume, or any other measurable property, a dropdown menu or selection of available materials, colors, or finishes, options for customization (e.g., size, attachments, modules, etc.), base cost, changes based on selected configurations or materials, a UI to enable a purchase, a UI to allow users to save their custom setup, user-based saving for future reference, visual feedback of selected options in real-time (color, material, dimension adjustments), interactive tools to inspect product dimensions (e.g., in 2D or 3D), options for users to view a product relative to an environment, options for users to view a product from multiple viewpoints such as a top, side, front, isometric, or exploded views for engineering/assembly clarity, filtering and searchability, details such as durability, texture, or finish, exploded views, internal structure, or component-level visuals, user feedback, etc.

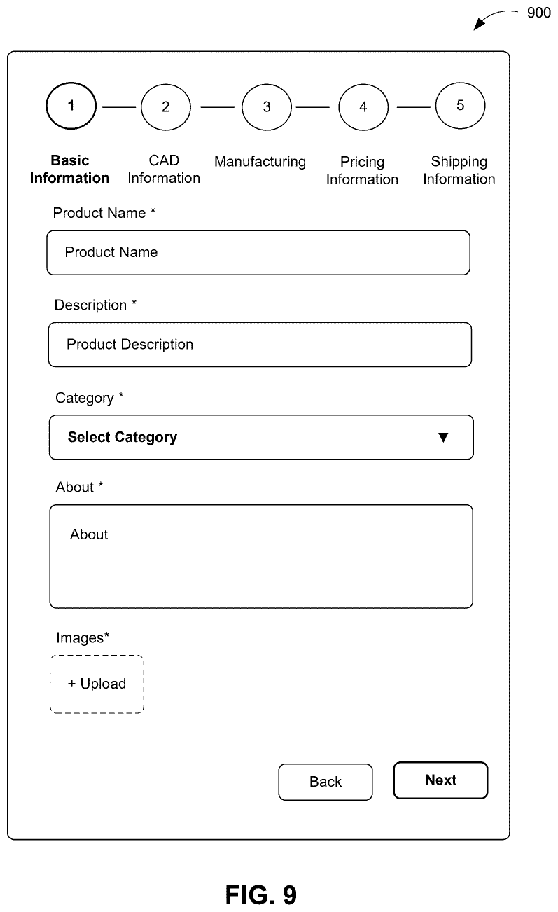

FIG. 9 illustrates a UI 900 to provide users such as CAD designers or sellers to input product information for virtual interface setup, in accordance with some implementations. For example, UI 900 enables a user to enter a product name, a product description, provide a selection from a dropdown menu (e.g., a selection from predefined categories such as furniture, electronics, jewelry, etc.), provide additional notes such as internal notes, seller-specific instructions, or tips about a CAD model (e.g., assembly notes, material suggestions, etc.), etc. UI 900 may further enable a user to upload images.

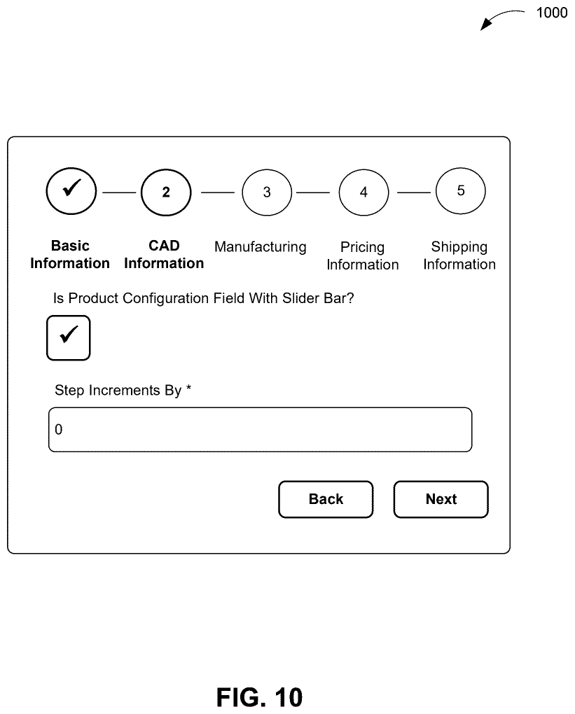

FIG. 10 illustrates a UI 1000 to provide users such as CAD designers or sellers to define configurable parameters for CAD models via UI elements such as sliders or step increments, in accordance with some implementations. For example, UI 1000 enables a user to define interactive, configurable parameters using CAD models enabling customization in the virtual interface to enable users to configure, for example, a parameter name, a value type (numeric, choice, Boolean, etc.), a default value, min/max values, step increments (e.g., for sliders), optional description or notes, etc.

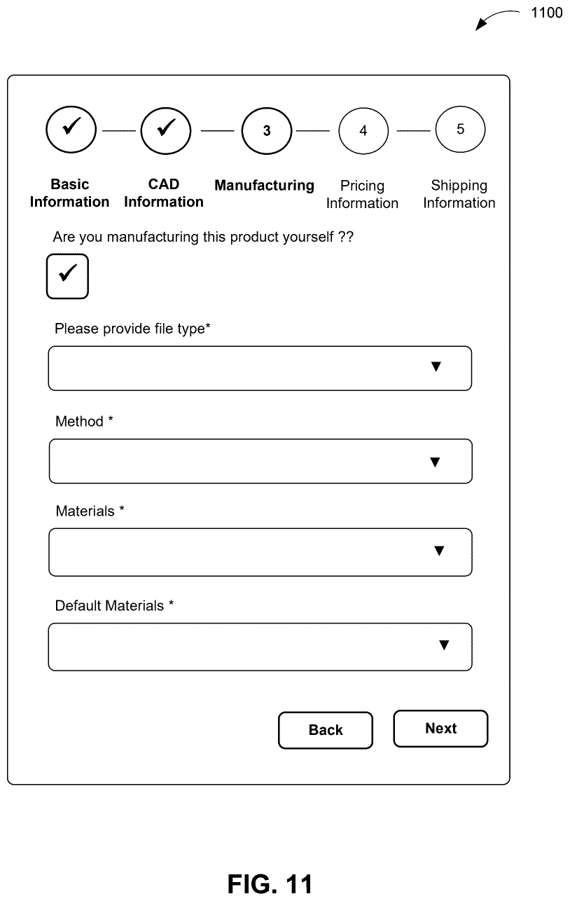

FIG. 11 illustrates a UI 1100 to enable users to collect manufacturing details to generate an MFS, determine an optimal method of manufacturing for a product and varying versions, and predict pricing, in accordance with some implementations. For example, UI 1100 enables a user to provide a file type (e.g., CAD) via a dropdown/select menu to determine a compatibility with manufacturing processes. Likewise, UI 1100 enables a user to select: a manufacturing method (3D printing, injection molding, laser cutting, etc.), associated materials (e.g., steel, polycarbonate, etc.) and default materials (e.g., plastic) via dropdown/select menus.

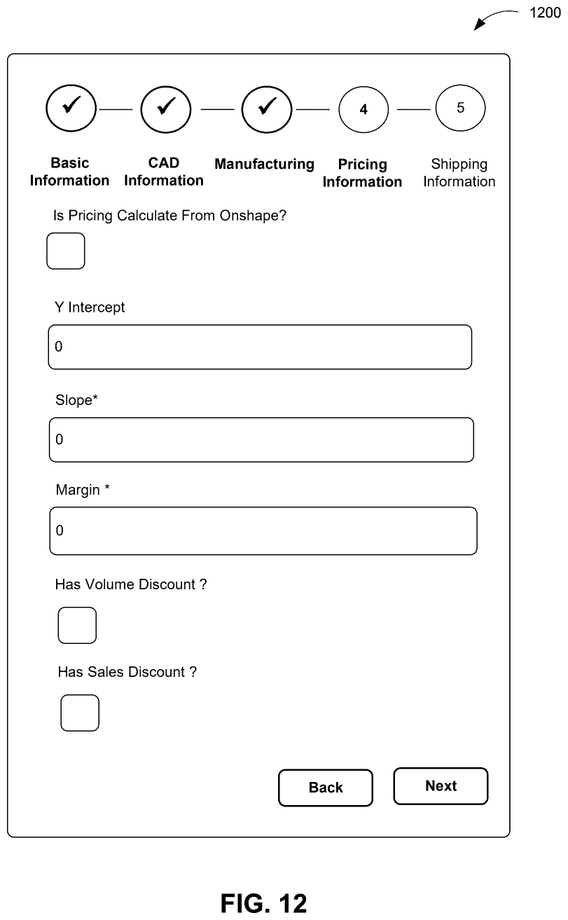

FIG. 12 illustrates a UI 1200 to enable users to collect additional input to further predict product pricing, in accordance with some implementations. For example, UI 1200 is configured to use model parameters such as Y-intercept (e.g., a starting price for production), slope (e.g., a rate at which a price changes relative to a selected variable), and margin (e.g., a desired profit margin) to adjust a pricing algorithm dynamically for each product.

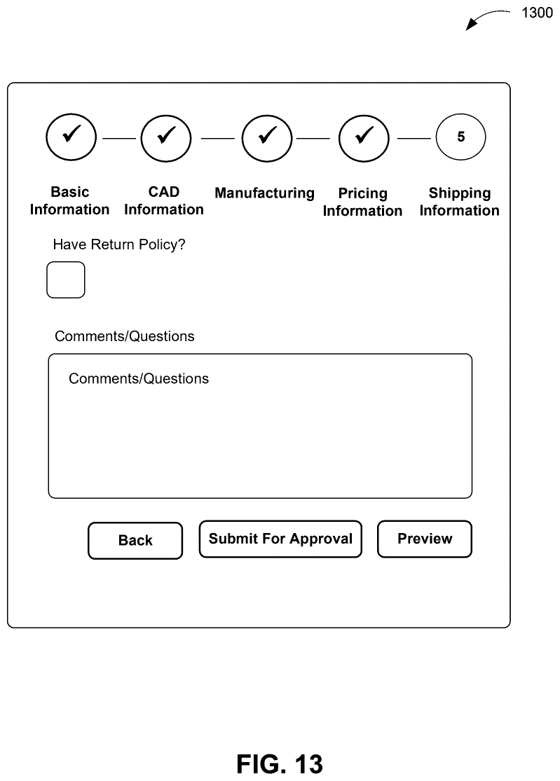

FIG. 13 illustrates a UI 1300 to enable users to collect seller information regarding product shipping, in accordance with some implementations. For example, UI 1300 is configured to provide details necessary to manage logistics, calculate delivery costs, and display estimated shipping options to buyers.

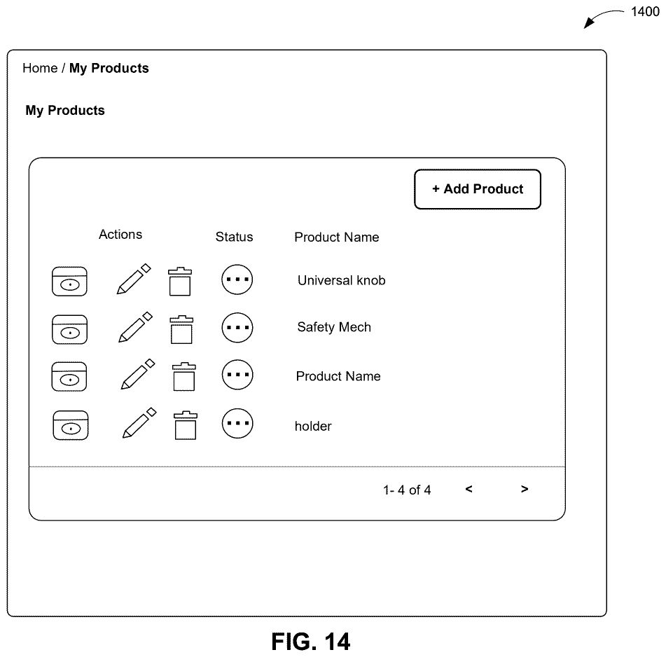

FIG. 14 illustrates a UI 1400 configured to provide sellers or designers a centralized view of all their products or virtual interfaces, in accordance with some implementations. For example, UI 1400 is configured to provide a user with: a virtual interface/product preview; quick access to edit or manage; status and key information views; and associated product descriptions or names.

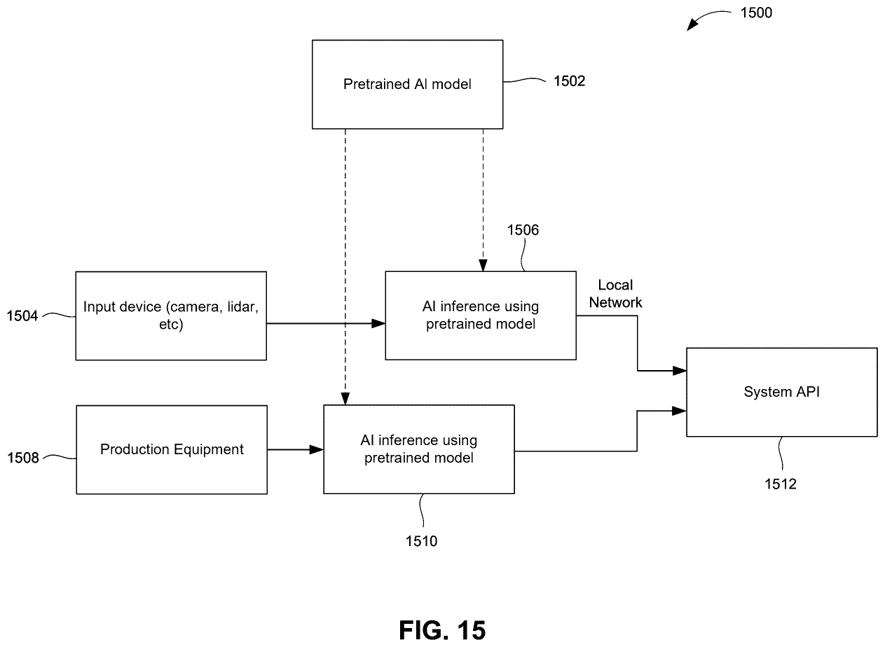

FIG. 15 illustrates a method 1500 for executing an AI inference process locally (on-edge) rather than relying on cloud-based processing, in accordance with some implementations. The method 1500 enables real-time, low-latency decision-making directly within on-site systems such as manufacturing equipment, sensors, or imaging devices using pre-trained AI models.

At block 1502, the method 1500 obtains a pre-trained AI model that has been previously trained on large-scale datasets and optimized for efficient on-device execution (e.g., via edge-specific model compression).

At block 1504, the method 1500 continuously obtains input data from on-site devices, including cameras, LIDAR sensors, microphones, or production line sensors. The data may represent real-time observations such as visual imagery, etc.

At block 1506, the method enables a pre-trained model to perform local AI processing (e.g., graph traversal execution to optimize configuration selection by eliminating non-viable options) to reduce delays with respect to data obtained from block 1504 (e.g., object detection, surface inspection, defect recognition, product dimension verification, etc.).

At block 1510, the method 1500 enables a pre-trained model to perform a local AI process to reduce delays with respect to data obtained from block 1508. For example, data obtained from block 1508 may include data captured from production equipment, such as, for example, torque sensors, temperature readings, machine vibrations, or process telemetry. Results of block 1510 may enable optimization of manufacturing parameters.

At block 1512, the method 1500 converts results of the perform local AI process performed via blocks 1506 and 1510 into standardized system API outputs to provide machine-readable data streams or control signals that may trigger automated actions (e.g., adjust calibration) and feed a real-time dashboard of a virtual interface.

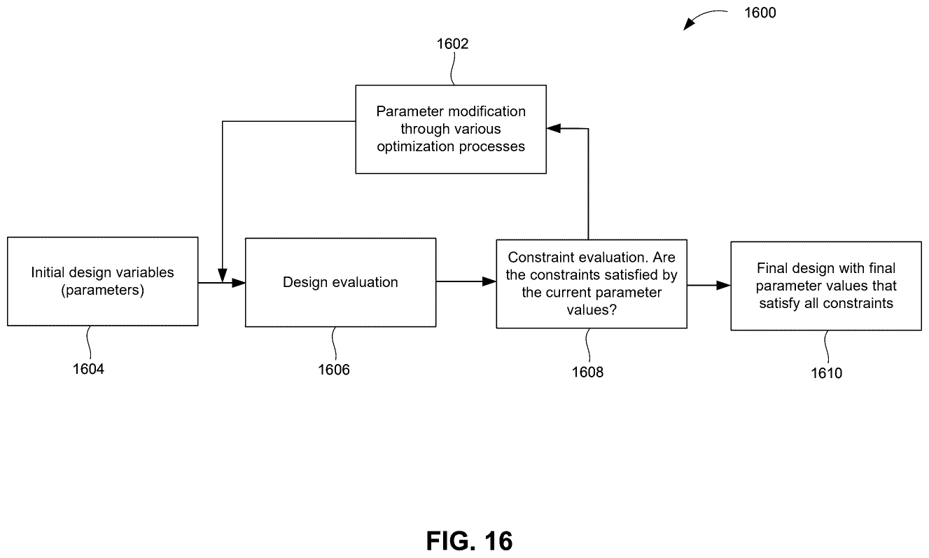

FIG. 16 illustrates a method 1600 for iteratively enabling parametric design and optimization to automatically refine product parameters to achieve predefined performance, manufacturability, and constraint conditions, in accordance with some implementations. The method 1600 may ensure that a resulting product design is both functionally optimal and production-ready while minimizing manual intervention and computational overhead.

At block 1602, the method 1600 obtains an initial set of design variables, such as geometry dimensions, material selections, structural parameters, etc. The initial set of design variables may be provided manually by the user, generated from historical data, or automatically inferred from product requirements and AI-driven predictions. The initial set of design variables are evaluated at block 1606 via, for example, simulation, analysis, or modeling tools to assess resulting design performance.

At block 1608, the method 1600 compares results from block 1606 with a predefined set of design constraints and objective functions which may include tolerances, cost thresholds, material limits, or performance targets. In some implementations, it may be determined if current parameter values satisfy all constraints. If the constraints are not satisfied, optimization algorithms may be applied in block 1602 to modify one or more parameters and automatically re-run the evaluation. If the constraints are satisfied, the method 1600 terminates the optimization at block 1602 and proceeds to block 1610 to create a final optimized design with converged parameter values for presentation to the user. The final optimized design may include a 3D model visualization which may be directly forwarded to manufacturing.

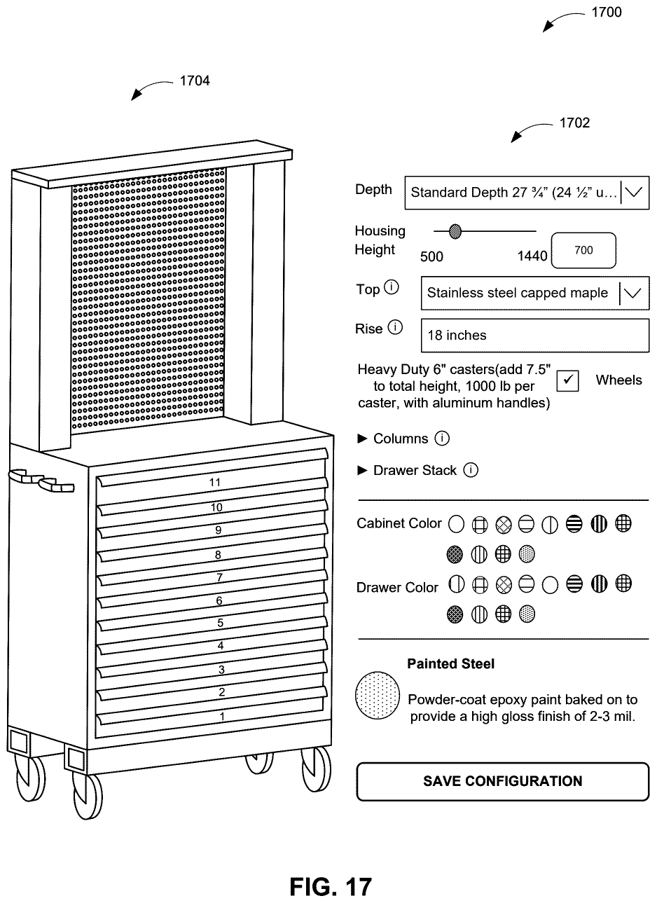

FIG. 17 illustrates an example 1700 of a configuration UI panel 1702 and 3D product render 1704 for a drawer system, in accordance with some implementations. The UI panel 1702 enables users to modify key design attributes such as dimensions, materials, and colors and observe immediate updates to the 3D product render 1704 thereby enabling real-time product personalization and manufacturability evaluation via direct interaction with a configurator engine. The UI panel 1702 may be designed as a modular UI element integrated into a virtual interface to enable direct user control over physical and aesthetic characteristics of the drawer system. The key design attributes may be modified via, for example, virtual sliders, dropdown menus, color palate selections, etc. In some implementations, the 3D product render 1704 may be configured to rotate, zoom, and provide inspection for drawer components from any angle. A rendering engine providing the 3D product render 1704 may be optimized for edge-based performance utilizing local GPU or device resources to minimize latency and enable fluid interaction.

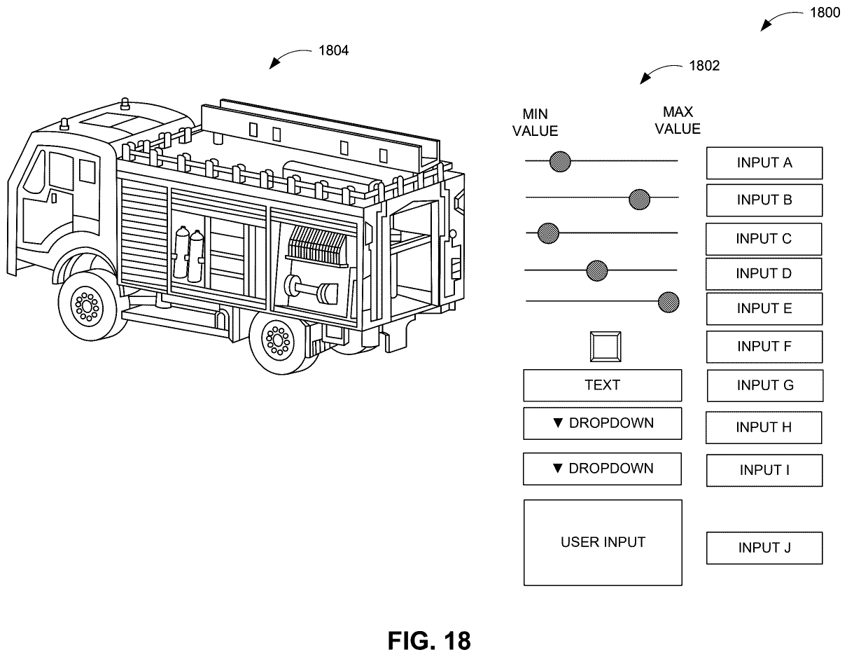

FIG. 18 illustrates an example 1800 of a user interface 1802 for creating and managing a complete vehicle (e.g., a firetruck) lifecycle configuration 1804 including new builds and component replacement, in accordance with some implementations. For example, the user interface 1802 may enable a parametric interface that accepts structured user inputs via sliders, dropdown menus, and checkboxes to enable configuration, cost estimation, and lifecycle management for each subsystem in a modular fashion.

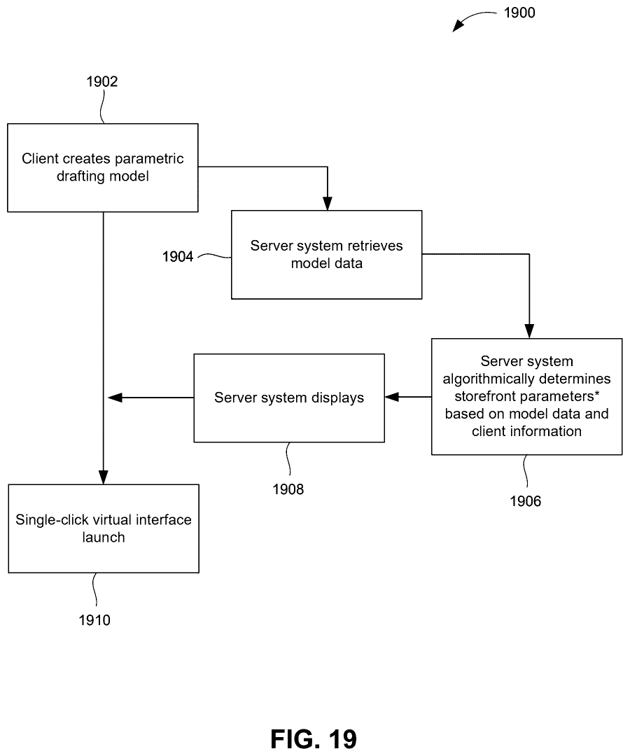

FIG. 19 illustrates a method 1900 for automatically generating and deploying a fully functional virtual interface from a parametric product model and associated client information, in accordance with some implementations. The method 1900 may use server-side AI inference to interpret model data, determine virtual interface design and configurator parameters, and render a virtual interactive interface that may be presented instantly.

At block 1902, the method 1900 enables a client to create or upload a parametric drafting model of a product (e.g., furniture, equipment, mechanical assembly, etc.). The model may include geometric data, configurable variables, materials, colors, pricing formulas, and metadata describing product features.

At block 1904, the method 1900 retrieves (e.g., via a server) the uploaded model, related product documentation, pricing and media assets (images, videos, AR models) and linked client information, such as company branding, website style, and prior virtual interface templates.

At block 1906, the method 1900 (via an AI system) analyzes and determines optimal parameters for the virtual interface based on the retrieved model data and client profile. For example, optimal parameters may correspond to layout and visual design style (e.g., based on brand and product type), embedded product configurator logic derived from the parametric model, pricing and availability modules, and recommended media presentation (e.g., 3D viewer, AR/VR mode, video embedding, etc.).

At blocks 1908 and 1910, the method 1900 automatically deploys and renders the virtual interface via a web server. The virtual interface may be, for example, embedded in a client's existing website, deployed as a standalone site or public Website, etc. Likewise, the virtual interface may be located on or embedded within a mobile device, a downloadable stand-alone application, a virtual reality (VR) interface, etc.

The method 1900 may be iterative such that if a client updates the model, pricing, or design, the virtual interface is re-generated and redeployed automatically such that each update automatically triggers a new version of the virtual interface. Likewise, the single click virtual interface launch architecture enables clients to go from product model to interactive interface in seconds thereby eliminating manual web design and configuration tasks. Accordingly, unlike conventional systems that require multiple user actions and manual design iterations, the method 1900 enables a single-click virtual interface launch with real-time 3D rendering and automated manufacturing integration.

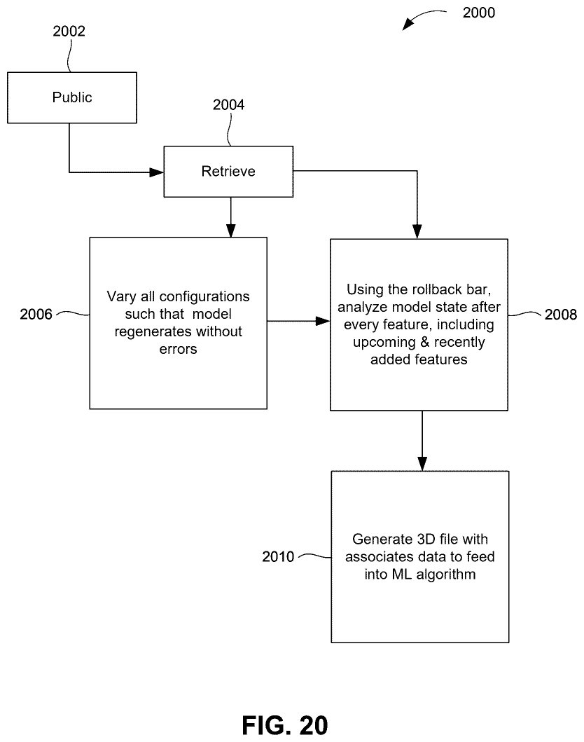

FIG. 20 illustrates a method 2000 for retrieving publicly available 3D CAD models, systematically varying corresponding configurations and feature history, and exporting structured 3D data along with parametric metadata for ML training, in accordance with some implementations.

At block 2002, the method 2000 automatically accesses a library of public CAD models using an API or an authorized dataset. The CAD models may be filtered via quality indicators such as successful regeneration rate, absence of model errors, and completeness of metadata (e.g., features, materials, dimensions). The selected CAD models may be configured to form a base dataset for training data generation.

At block 2004, the method 2000 retrieves the selected CAD models for processing via blocks 2006 and 2008. At block 2006, the method 2000 algorithmically modifies each configurable parameter within its valid design bounds and subsequent to each modification, a CAD model is regenerated to ensure it may be rebuilt without geometry or dependency errors. At block 2008, the method 2000 may use a rollback bar to iteratively analyze the CAD model after each feature operation. For example, metrics such as regeneration time, feature complexity, face/edge count, volume changes, and topological consistency may be recorded to enable tracking of how each new or recently added feature impacts model stability, complexity, and manufacturability.

At block 2010, the method 2000 generates 3D Files and associated metadata for ML input. The 3D files form a labeled dataset suitable for training ML models with respect to predictive feature regeneration, automated constraint resolution, geometry optimization and feature ordering, manufacturing feasibility prediction, etc.

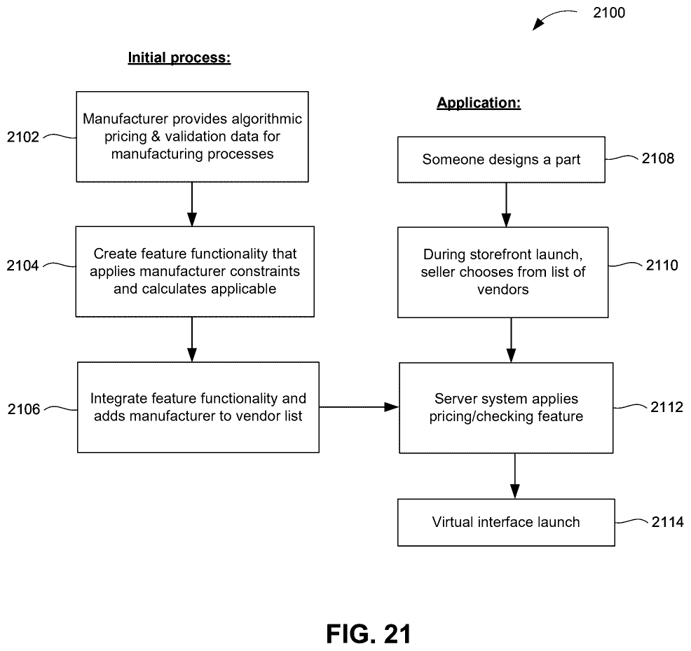

FIG. 21 illustrates a method 2100 for automatically launching a virtual interface that integrates manufacturer-specific pricing, production constraints, and feature functionality, in accordance with some implementations. The method 2100 may enable real-time validation, vendor selection, and virtual interface deployment based on a user-designed product or uploaded model. Blocks 2102, 2104 and 2106 represent an initial process to provide a vendor list.

At block 2102, the method 2100 obtains algorithmic pricing models and validation parameters defining manufacturability constraints from each participating manufacturer. At block 2104, the method 2100 builds feature functionality modules that encode each manufacturer's constraints into computational rules. For example, rules for: automatic rounding of sharp corners for injection molding, replacing unsupported thin-wall geometries for 3D printing, mapping materials to available supplier inventories, etc. At block 2106, the method 2100 integrates validated and constraint-applied feature functionality modules into a shared manufacturer capability database for application to a vendor list.

At block 2108, the method 2100 enables a user to initiate a design session to upload a model using the virtual interface configurator. At block 2110, the method 2100 enables the user to select a vendor.

At block 2112, the method 2100 obtains results from blocks 2106 and 2112 to apply a pricing check-in feature by for example: validating that all pricing and manufacturability parameters remain consistent to ensure that any subsequent user modification (e.g., resizing, material change, etc.) automatically triggers a revalidation and repricing process.

At block 2114, the method 2100 system automatically generates and launches a virtual interface that may include: an interactive 3D configurator linked to manufacturer constraints, dynamic pricing updates via a pricing check-in feature, real-time vendor selection, ordering, and fulfillment initiation, etc. The virtual interface may be embedded in a public or private web platform thereby completing an end-to-end product-to-interface deployment cycle. Accordingly, the method 2100 enables one-click deployment of a fully operational virtual interface directly tied to manufacturer data, pricing logic, and constraint-based configuration.

Accordingly, the method improves upon existing technologies by integrating single-click interface generation, edge-based AI processing, and automated manufacturing initiation, achieving significant reductions in latency (e.g., 70%) and memory usage (e.g., 50%), while enabling non-expert users to create complex designs in hours rather than days.

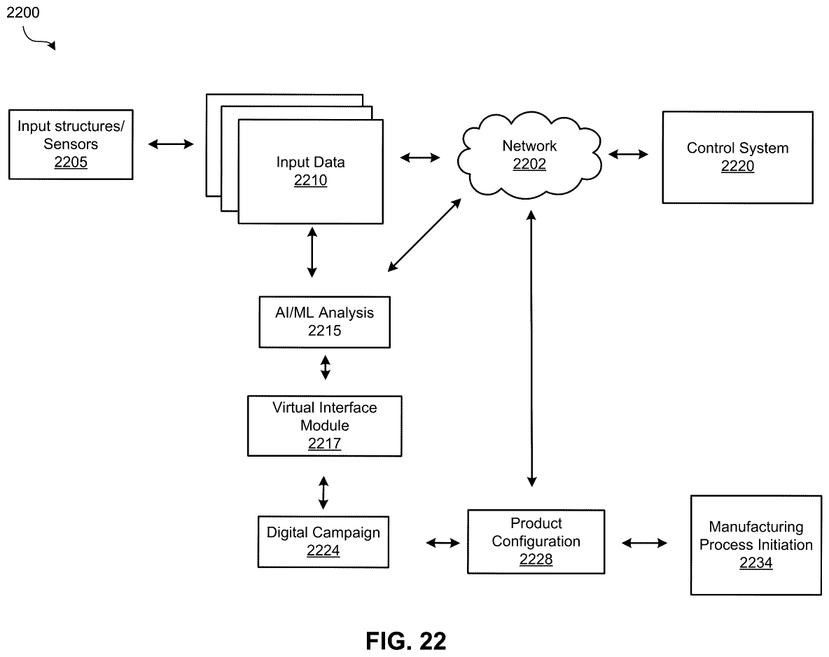

FIG. 22 illustrates a framework 2200 configured to automatically generate a virtual interface embedded in a public website (or a mobile device, a downloadable stand-alone application, a virtual reality (VR) interface, etc.), populated with interactive 3D renderings, configurators, and branding-aligned assets in response to a single user action, in accordance with some implementations. The framework 2200 includes input structures/sensors 2205 (e.g., image or audio sensors, keyboard or keypads, APIs, databases, applications, etc.) configured to obtain input data 2210 for generating (via a AI/ML module 2215 including an AI and/or rule-based engine and a virtual interface module 2217) a virtual interface. Likewise, the framework 2200 includes a digital campaign module 2224, a product configuration module 2228, a manufacturing process initiation module 2234 and a control system 2220 that, in some implementations, communicates over a data communication network 2202, e.g., a local area network (LAN), a wide area network (WAN), the Internet, a mobile network, or a combination thereof. Components of AI/ML module 2215, virtual interface module 2217, digital campaign module 2224, product configuration module 2228, and manufacturing process initiation module 2234 may include any combination of specialized hardware and software and may be included by or integrated with any device or server, the control system 320 or any combination thereof.

In some implementations, the virtual interface generation process is initiated when a user provides input (e.g., input data 2210) specifying product needs or preferences. The input is received via input structures/sensors 2205 and may include, inter alia, text data such as typed descriptions, keywords, structured parameters, etc.; voice data such as spoken commands, conversational prompts, etc.; image data such as uploaded photos or videos, sketches, reference visuals, CAD files, etc.; 3D scan or sensor data such as dimensional or geometric input from scanning devices; and external application or API integration data such as specifications, product data, requirements from third-party design or business applications, etc.

In response to receiving the input data 2210, AI/ML module 2215 is configured to analyze the input data 2210 to: (a) identify key attributes, requirements, and constraints; and (b) match the results against existing product models or assemblies stored in a database such that if a match is found, AI/ML module 2215 is configured to determine how the product may be configured or customized to meet user specifications and if no existing product model is suitable, AI/ML module 2215 is configured to extract core geometric, material, and functional components (e.g., dimensions, shapes, textures, tolerances) to generate a new base configurable model.

Based on output from AI/ML module 2215 and in response to a single user action (e.g., activating a UI element such as a virtual button), virtual interface module 2217 is configured automatically: (a) create a virtual interface embedded within a public website, a mobile device, a downloadable stand-alone application, a virtual reality (VR) interface, etc.; (b) populate the virtual interface with relevant configurators, pricing tools, product information, and visual assets; (c) embed (within the virtual interface) interactive 3D renderings of the configured product that may be updated in real time as users make adjustments; and (d) customize a look and layout of the virtual interface according to the company's branding or user preferences.

In some implementation, digital campaign module 2224 may be configured to automatically generate associated marketing assets and digital campaigns, including: marketing materials (brochures, images, 3D previews, product descriptions, etc.); digital advertisements and social media posts pre-formatted for publishing; email campaigns or landing pages aligned with the newly created virtual interface; and recommendations for optimal campaign timing, channels, and audiences using AI-based market analysis.

In some implementations, product configuration module 2228 in combination with virtual interface module 2217 may be configured to: (a) configure product options (e.g., materials, finishes, dimensions, components, etc.); (b) provide real-time pricing updates; (c) initiate purchase and manufacturing requests directly through the virtual interface; and (d) receive AI-generated recommendations for compatible accessories or bundles. Once an order (for a product or structure) is confirmed, manufacturing process initiation module 2234 is configured to: (a) analyze product specifications and materials to select an optimal manufacturing process (e.g., CNC machining, molding, assembly line production, etc.); (b) generate and transmit digital build files (e.g., CAD files, G-code files, etc.) to a selected facility for production; and (c) initiate manufacturing, delivery, and fulfillment workflows automatically. Manufacturing process initiation module 2234 may additionally provide continuous visibility across the product lifecycle. For example, manufacturing process initiation module 2234 may provide: (a) real-time updates with respect to a manufacturing progress, shipment, and delivery; (b) integration with logistics platforms for tracking and coordination; and (c) post-delivery feedback capture and AI-driven insights to refine future virtual interface or product configurations.

Framework 2200 may provide improvements to virtual interface development technology and the functioning of a computer system as follows:

Framework 2200 provides improvements to computer data transmission latency and efficiency by enabling AI systems to pre-process sensor data in edge computing (e.g., on-device ML inference) to cache partial 3D models thereby reducing server round-trips (e.g., by about 70%) during real-time updates. The improvements to computer data transmission latency and efficiency enable faster rendering (e.g., <100 ms updates) thereby conserving bandwidth and CPU cycles vs. cloud-only processing.

Framework 2200 provides improvements to computer resource optimization by executing rule-based algorithms to prune irrelevant model variants using graph-based pruning thereby limiting generated configurations to, for example, less than 50 per query. The improvements to computer resource optimization may optimize memory usage by reducing a RAM footprint by, for example, 50% thereby enabling deployment with respect to low-resource devices such as mobile devices.

Framework 2200 provides improvements to product design technology by using AI systems to fuse incomplete inputs (e.g., sketch and voice specifications) to auto-generate parametric constraints thereby enabling non-experts to iterate designs significantly faster (e.g., 3 times faster). These improvements democratize CAD functionality by reducing design cycles from days to hours.

Framework 2200 provides improvements product manufacturing technology by using post-selection to output G-code with embedded tolerances from AI analysis thereby auto-adjusting for material variances in additive manufacturing. These improvements increase yield rates by, for example, 20-30% for 3D printing by preempting defects.

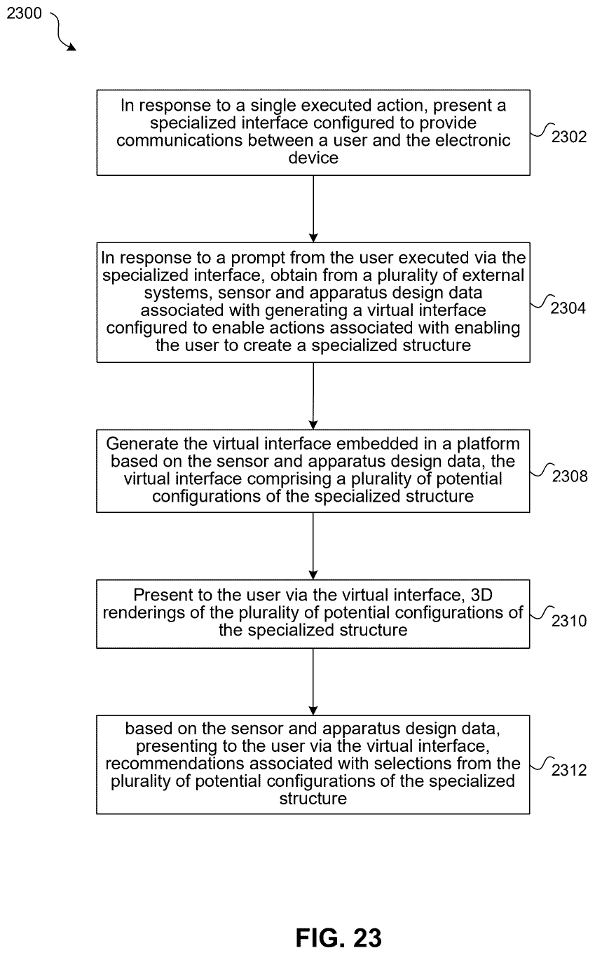

FIG. 23 is a flowchart representation of an exemplary method 2300 that generates a configurable virtual interface to enable iterative design and construction of a specialized structure, in accordance with some implementations. In some implementations, the method 2300 is performed by a device, such as a mobile device, a desktop, laptop, a wearable device, or a server device. In some implementations, the method 2300 is performed by processing logic, including hardware, firmware, software, or a combination thereof. In some implementations, the method 2300 is performed by a processor executing code stored in a non-transitory computer-readable medium (e.g., a memory). Each of the blocks in the method 2300 may be enabled and executed in any order.

At block 2302, the method 2300 in response to a single executed action, presents a specialized interface configured to provide communications between a user and the electronic device. For example, a UI 900 or interface 114 to provide users such as CAD designers or sellers to input product information for virtual interface setup as described with respect to FIGS. 1 and 9.

In some implementations, the single executed action may be an action such as, for example, activating an electro/mechanical switch, activating a virtual switch, a user gesture obtained via sensors of the electronic device, etc.

At block 2304, the method 2300 in response to a prompt from the user executed via the specialized interface, obtains from a plurality of external systems, sensor and apparatus design data associated with generating a virtual interface configured to enable actions associated with enabling the user to create a specialized structure. For example, input structures/sensors 2205 (e.g., image or audio sensors, keyboard or keypads, APIs, databases, applications, etc.) configured to obtain input data 2210 as described with respect to FIG. 22.

In some implementations, the prompt is a text prompt, a voice prompt, or a user gesture prompt obtained via sensors of the device.

In some implementations, the sensor and apparatus design data comprises user specifications including, for example, sensor data, scanned data, (e.g., blueprints or mechanical or electrical schematics), portable document format (PDF) files, computer aided design (CAD) models, and external application or application programming interface (API) integration information.

In some implementations, the sensor and apparatus design data is obtained via a combination of sensors such as motion sensors, global positioning satellite (GPS) sensors, image sensors, biometric sensors, microphones, etc.

In some implementations, the specialized structure is a structure such as a software structure, a hardware structure, an electrical device, a mechanical device, an electro/mechanical device, etc.

At block 2308, the method 2300 generates the virtual interface embedded in a platform based on the sensor and apparatus design data. The virtual interface includes a plurality of potential configurations of the specialized structure. For example, a virtual interface may be: embedded in a client's existing website, deployed as a standalone site or public Website, etc., a mobile device, a downloadable stand-alone application, a virtual reality (VR) interface, etc. as described with respect to FIG. 19.

In some implementations, generating the virtual interface is performed via execution of a rule-based algorithm.

In some implementations, wherein generating the virtual interface is performed via execution of an artificial intelligence (AI) implemented algorithm configured to execute local AI processes to minimize data transmission latency. For example, the AI algorithm may be configured to analyze the sensor and apparatus design data with respect to existing structures to determine if an existing structure may be configured to create the specialized structure and to auto-generate parametric constraints for iterative design of the specialized structure.

If the AI algorithm determines that the existing structure may be configured to create the specialized structure, a 3D rendering of the existing structure may modified to create the specialized structure and based on the 3D rendering, a secondary action may be executed for triggering a design and manufacturing process for creating the specialized structure from a modified version of the existing structure.

If the AI algorithm determines that the existing structure may not be configured to create the specialized structure (based on the sensor and apparatus design data), a 3D rendering of a new base configurable model adaptable to be modified to create the specialized structure is generated and based on the 3D rendering, a secondary action is executed for triggering a design and manufacturing process for creating the specialized structure from a modified version of the new base configurable model.

At block 2310, the method 2300 presents to the user via the virtual interface, 3-dimensional (3D) renderings of the plurality of potential configurations of the specialized structure. For example, a module 210 may be configured to automatically create 3D renderings for digital presentation as described with respect to FIG. 2.

In some implementations, the 3D renderings may include video files configured to demonstrate functionality of the plurality of potential configurations of the specialized structure in 3D space.

In some implementations, in response to the presented 3D renderings, a user may select via the virtual interface, a first configuration from the plurality of potential configurations of the specialized structure and in response to the selection, a control signal is provided to an automation system (e.g., a robotic system, an automated assembly line, etc.) to initiate an automated build of the specialized structure in accordance with the first configuration.

In some implementations, the 3D renderings of the plurality of potential configurations of the specialized structure are presented to the user in 3D space of a virtual environment via the virtual interface such that the 3D rendering is viewable from multiple different viewpoints.

In some implementations, memory usage is optimized and reduced by removing non-viable configurations of the plurality of potential configurations via graph traversal execution.

At block 2312, the method 2300 based on the sensor and apparatus design data, presents to the user via the virtual interface, recommendations associated with selections from the plurality of potential configurations of the specialized structure. For example, an AI model may be configured to evaluate the manufacturability of a product/structure and recommend an optimal production method based on technical, operational, and market factors as described with respect to FIG. 7.

In some implementations in response to the recommendations, a selection of a first configuration from the plurality of potential configurations of the specialized structure may be receiving from the user via the virtual interface and in response to the selection, a secondary action triggers a design and manufacturing process to enable rendering, building and delivery of the specialized structure generated in accordance with the first configuration. In some implementations, triggering the design and manufacturing process may include generating a programming language used for 3D printing to provide step-by-step instructions to print each layer of an object with artificial intelligence (AI) derived tolerances for variance compensation with respect to the first configuration.

In some implementations, the specialized structure generated in accordance with the first configuration may include an existing structure modified in accordance with the first configuration. In some implementations, the specialized structure generated in accordance with the first configuration may include a new structure designed and built in accordance with the first configuration.

In some implementations, invalid configurations within the sensor and apparatus design data may be detected and in response, updated recommendations may be provided to the user via the virtual interface.

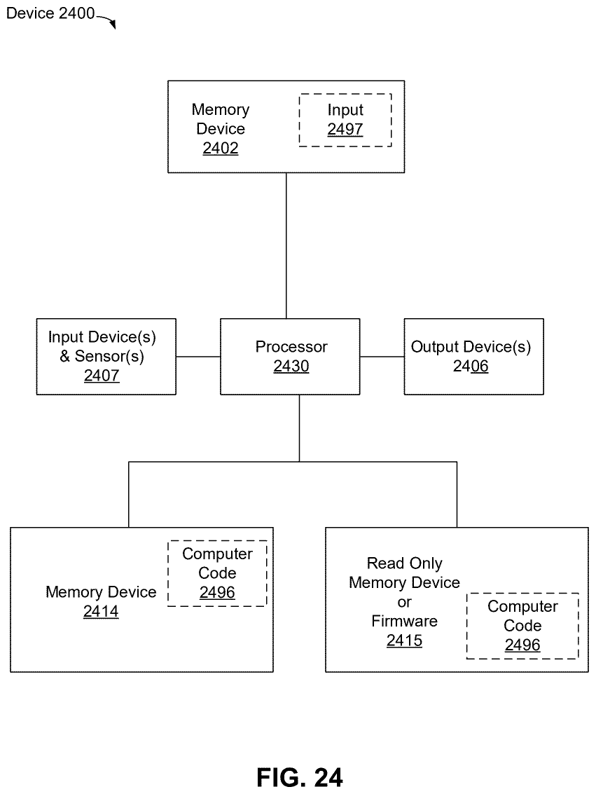

FIG. 24 illustrates a hardware device 2400 (e.g., a mobile hardware device, a Web server, a hardware device, etc.) used by or comprised a system for improving software/hardware for improving virtual interface technology associated with creating a one click virtual interface launch, in accordance with some implementations.

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing apparatus receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, spark, R language, or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, device (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing device to produce a machine, such that the instructions, which execute via the processor of the computer or other programmable data processing device, create means for implementing the functions/acts specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing device, or other device to cause a series of operational steps to be performed on the computer, other programmable device or other device to produce a computer implemented process, such that the instructions which execute on the computer, other programmable device, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The hardware device 2400 illustrated in FIG. 24 includes a processor 2430, an input device/sensors 2407 coupled to the processor 2430, an output device 2406 coupled to the processor 2430, and memory devices 2402 and 2414 each coupled to the processor 2430. The input device/sensors 2407 may be, inter alia, a keyboard, a mouse, a camera, a touchscreen, any type of sensors, etc. The output device 2406 may be, inter alia, a printer, a plotter, a computer screen, a magnetic tape, a removable hard disk, a floppy disk, etc. The memory devices 2402 and 2414 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 2414 includes a computer code 2496. The computer code 2496 includes algorithms for improving virtual interface technology associated with creating a one click virtual interface launch. The processor 2430 executes the computer code 2496. The memory device 2402 includes input data 2497. The input data 2497 includes input required by the computer code 2402. The output device 2406 displays output from the computer code 2496. Either or both memory devices 2402 and 2414 (or one or more additional memory devices Such as read only memory device or firmware 2415) may include algorithms (e.g., the algorithms of FIGS. 2-7, 15-16, 19-21 and 23) and may be used as a computer usable medium (or a computer readable medium or a program storage device) having a computer readable program code embodied therein and/or having other data stored therein, wherein the computer readable program code includes the computer code 2496. Generally, a computer program product (or, alternatively, an article of manufacture) of the hardware device 2400 may include the computer usable medium (or the program storage device).

In some implementations, hardware device 2400 illustrated in FIG. 24 may be included by or be associated with cloud-based architectures, server and client side programming languages, libraries, frameworks, etc.

In some embodiments, rather than being stored and accessed from a hard drive, optical disc or other writeable, rewriteable, or removable hardware memory device 2414, stored computer program code 2496 (e.g., including algorithms) may be stored on a static, nonremovable, read-only storage medium such as a Read-Only Memory (ROM) device 2415, or may be accessed by processor 2430 directly from such a static, nonremovable, read-only medium 2415. Similarly, in some embodiments, stored computer program code 2496 may be stored as computer-readable firmware 2415, or may be accessed by processor 2430 directly from such firmware 2415, rather than from a more dynamic or removable hardware data-storage device 2414, such as a hard drive or optical disc.

While FIG. 24 shows the hardware device 2400 as a particular configuration of hardware and software, any configuration of hardware and software, as would be known to a person of ordinary skill in the art, may be utilized for the purposes stated supra in conjunction with the particular hardware device 2400 of FIG. 24. For example, the memory devices 2402 and 2414 may be portions of a single memory device rather than separate memory devices.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method comprising:
at an electronic device having at least one processor:
in response to a single executed action, presenting a specialized interface configured to provide communications between a user and the electronic device;
in response to a prompt from the user executed via the specialized interface, obtaining from a plurality of external systems, sensor and apparatus design data associated with generating a virtual interface configured to enable actions associated with enabling the user to create a specialized structure;
generating the virtual interface embedded in a platform based on the sensor and apparatus design data, the virtual interface comprising a plurality of potential configurations of the specialized structure;
presenting to the user via the virtual interface, 3-dimensional (3D) renderings of the plurality of potential configurations of the specialized structure; and
based on the sensor and apparatus design data, presenting to the user via the virtual interface, recommendations associated with selections from the plurality of potential configurations of the specialized structure.

2. The method of claim 1, further comprising:
in response to the recommendations, receiving from the user via the virtual interface, a selection of a first configuration from the plurality of potential configurations of the specialized structure; and
in response to the selection, executing a secondary action for triggering a design and manufacturing process enabling rendering, building and delivery of the specialized structure generated in accordance with the first configuration, wherein said triggering the design and manufacturing process comprises generating a programming language used for 3D printing to provide step-by-step instructions to print each layer of an object with artificial intelligence (AI) derived tolerances for variance compensation with respect to the first configuration.

3. The method of claim 2, wherein the specialized structure generated in accordance with the first configuration comprises an existing structure modified in accordance with the first configuration.

4. The method of claim 2, wherein the specialized structure generated in accordance with the first configuration comprises a new structure designed and built in accordance with the first configuration.

5. The method of claim 1, wherein said generating the virtual interface is performed via execution of a rule-based algorithm.

6. The method of claim 1, wherein said generating the virtual interface is performed via execution of an artificial intelligence (AI) implemented algorithm configured to execute local AI processes to minimize data transmission latency.

7. The method of claim 6, wherein the recommendations comprise AI-generated recommendations generated based on manufacturability, cost, or user preferences, and wherein the method further comprises:
analyzing via the AI algorithm based on the AI-generated recommendations, the sensor and apparatus design data with respect to existing structures to determine if an existing structure may be configured to create the specialized structure and to auto-generate parametric constraints for iterative design of the specialized structure.

8. The method of claim 7, wherein the AI algorithm determines that the existing structure may be configured to create the specialized structure, and wherein the method further comprises:
generating, a 3D rendering of the existing structure modified to create the specialized structure; and
based on the 3D rendering, initiating a design and manufacturing process with a secondary action for creating the specialized structure from a modified version of the existing structure.

9. The method of claim 7, wherein the AI algorithm determines that the existing structure may not be configured to create the specialized structure, and wherein the method further comprises:
based on the sensor and apparatus design data, generating a 3D rendering of a new base configurable model adaptable to be modified to create the specialized structure; and
based on the 3D rendering, initiating a design and manufacturing process with a secondary action for creating the specialized structure from a modified version of the new base configurable model.

10. The method of claim 1, wherein the single executed action is an action selected from the group consisting of activating an electro/mechanical switch, activating a virtual switch, and a user gesture obtained via sensors of the electronic device.

11. The method of claim 1, wherein the prompt is a text prompt, a voice prompt, or a user gesture prompt obtained via sensors of the device.

12. The method of claim 1, wherein the sensor and apparatus design data comprises user specifications selected from the group consisting of sensor data, scanned data, portable document format (PDF) files, computer aided design (CAD) models, and external application or application programming interface (API) integration information.

13. The method of claim 1, wherein the sensor and apparatus design data is obtained via a combination of sensors selected from the group consisting of motion sensors, global positioning satellite (GPS) sensors, image sensors, biometric sensors and microphones.

14. The method of claim 1, wherein the 3D renderings comprise video files configured to demonstrate functionality of the plurality of potential configurations of the specialized structure in 3D space.

15. The method of claim 1, wherein the specialized structure comprises a structure selected from the group consisting of a software structure, a hardware structure, an electrical device, a mechanical device, and an electro/mechanical device.

16. The method of claim 1, further comprising:
in response to the presented 3D renderings, receiving from the user via the virtual interface, a selection of a first configuration from the plurality of potential configurations of the specialized structure; and
in response to the selection, providing a control signal to an automation system initiating an automated build of the specialized structure in accordance with the first configuration.

17. The method of claim 1, wherein the 3D renderings of the plurality of potential configurations of the specialized structure are presented to the user in 3D space of a virtual environment via the virtual interface such that the 3D rendering is viewable from multiple different viewpoints.

18. The method of claim 1, further comprising:
optimizing and reducing memory usage by removing non-viable configurations of the plurality of potential configurations via graph traversal execution.

19. The method of claim 1, further comprising:
detecting invalid configurations within the sensor and apparatus design data; and
based on the detected invalid configurations, providing updated recommendations to the user via the virtual interface.

20. A system comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
in response to a single executed action, presenting a specialized interface configured to provide communications between a user and the electronic device;
in response to a prompt from the user executed via the specialized interface, obtaining from a plurality of external systems, sensor and apparatus design data associated with generating a virtual interface configured to enable actions associated with enabling the user to create a specialized structure;
generating the virtual interface embedded in a platform based on the sensor and apparatus design data, the virtual interface comprising a plurality of potential configurations of the specialized structure;
presenting to the user via the virtual interface, 3D renderings of the plurality of potential configurations of the specialized structure; and
based on the sensor and apparatus design data, presenting to the user via the virtual interface, recommendations associated with selections from the plurality of potential configurations of the specialized structure.

21. A non-transitory computer-readable storage medium storing program instructions executable via one or more processors to perform operations comprising:
in response to a single executed action, presenting a specialized interface configured to provide communications between a user and the electronic device;
in response to a prompt from the user executed via the specialized interface, obtaining from a plurality of external systems, sensor and apparatus design data associated with generating a virtual interface configured to enable actions associated with enabling the user to create a specialized structure;
generating the virtual interface embedded in a platform based on the sensor and apparatus design data, the virtual interface comprising a plurality of potential configurations of the specialized structure;
presenting to the user via the virtual interface, 3D renderings of the plurality of potential configurations of the specialized structure; and
based on the sensor and apparatus design data, presenting to the user via the virtual interface, recommendations associated with selections from the plurality of potential configurations of the specialized structure.
